(19) United States
(12) Patent Application Publication
(10) Pub. No.: US 2026/0348527 A1
(43) Pub. Date: Nov. 5, 2026

(54) INTEGRATED COOLING TOWER

(71) Applicant: NET Power LLC, Durham, NC (US)

(72) Inventors: Nathan Davis, Kaysville, UT (US); Sang Muk Kwark, Holly Springs, NC (US); Erhan Sahin, Katy, TX (US)

(73) Assignee: NET Power LLC, Durham, NC (US)

(21) Appl. No.: 19/645,625

(22) Filed: Apr. 13, 2026

Related U.S. Application Data
(60) Provisional application No. 63/788,594, filed on Apr. 14, 2025.

(51) Int. Cl. F17C 7/04

(52) U.S. Cl. CPC F17C 7/04; F17C 2221/011; F17C 2223/0161; F17C 2225/0123; F17C 2227/0135; F17C 2227/0316; F17C 2227/0395; F17C 2270/0581

(57) ABSTRACT

Methods, systems, and devices for heating a process stream in a cooling tower are provided herein. The cooling tower includes a droplet maker for generating droplets and a collection basin for collecting the droplets as a pool of liquid. A primary indirect-contact heat exchanger (1st ICHE) is immersed in the pool of liquid in the collection basin. The 1st ICHE heats the process stream by indirect-contact heat exchange, cooling the pool of liquid. One or more secondary indirect-contact heat exchangers (2nd ICHEs) are in the cooling tower. The one or more 2nd ICHEs further heat the process stream by indirect-contact heat exchange cooling the droplets.

### CROSS-REFERENCE TO RELATED APPLICATIONS

This application claims the benefit of U.S. Provisional Patent Application No. 63/788,594, filed Apr. 14, 2025 and entitled “Integrated Cooling Tower,” the entire contents of which are incorporated by reference herein.

### TECHNICAL FIELD

The present disclosure relates to systems and methods for cooling a process stream in a cooling tower, for example in oxy-fuel combustion systems.

### BACKGROUND

Combustion systems, including the Allam Cycle, may utilize a carbonaceous fuel, an oxidant stream, and a recycled carbon dioxide stream to produce energy. The oxidant and recycle streams require energy inputs to produce. For certain details of the Allam Cycle, see U.S. Pat. No. 8,596,075, the entire contents of which are incorporated by reference herein.

### SUMMARY

In some examples, the disclosure provides a system for heating a process stream through a cooling tower, the cooling tower consisting of a droplet maker for generating droplets and a collection basin for collecting the droplets as a pool of liquid. The system includes a primary indirect-contact heat exchanger (1st ICHE) immersed in the pool of liquid in the collection basin, the 1st ICHE to heat the process stream by indirect-contact heat exchange cooling the pool of liquid. The system includes one or more secondary indirect-contact heat exchangers (2nd ICHEs) in the cooling tower, the one or more 2nd ICHEs to further heat the process stream by indirect-contact heat exchange cooling the droplets.

In some examples, the process stream includes one or more fluids selected from the group consisting of oxygen, nitrogen, natural gas, and argon.

In some examples, the 1st ICHE includes one or more elements selected from the group consisting of tube bundles, pipes, U-tubes, finned tubes, improved tubes, tubes with turbulator insert, twisted tubes, spirals, and corrugated tubes.

In some examples, the one or more 2nd ICHEs include one or more elements selected from the group consisting of tube bundles, pipes, U-tubes, finned tubes, improved tubes, tubes with turbulator insert, twisted tubes, spirals, and corrugated tubes.

In some examples, the system includes one or more scrapers to scrape ice off of the 1st ICHE, the one or more 2nd ICHEs, or combinations thereof.

In some examples, the system includes one or more heaters to melt ice off of the 1st ICHE, the one or more 2nd ICHEs, or combinations thereof.

In some examples, the system includes an air-separation unit to produce the process stream, the process stream consisting essentially of oxygen for use in an oxy-fuel combustion system; piping to transport cooled liquid from the pool of liquid to the oxy-fuel combustion system to cool one or more unit operations in the oxy-fuel combustion system; and second piping to transport the process stream to a combustor of the oxy-fuel combustion system.

In some examples, the system includes a liquified oxygen storage tank to provide the process stream, the process stream consisting essentially of liquid oxygen for use in an oxy-fuel combustion system; piping to transport cooled liquid from the pool of liquid to the oxy-fuel combustion system to cool one or more unit operations in the oxy-fuel combustion system; and second piping to transport the process stream to a combustor of the oxy-fuel combustion system.

In some examples, the cooling tower is open to allow passage of air through the droplets to further cool the droplets.

In some examples, the system includes one or more blowers to force air through the cooling tower to further cool the droplets.

In some examples, the droplet maker includes a bubble tray to create the droplets.

In some examples, the droplet maker includes an open tray to create the droplets.

In some examples, the droplet maker includes a sprayer to create the droplets.

In some examples, the system includes a second cooling tower, the cooling tower to operate while the second cooling tower de-ices, and the second cooling tower to operate while the cooling tower de-ices.

In some examples, the system includes a plurality of additional cooling towers, wherein the process stream of the cooling tower forms the fluid process stream of a next cooling tower of the plurality of additional cooling towers.

In some examples, the disclosure provides a system for heating a liquid process stream in a cooling tower. The cooling tower may include a droplet maker and a collection basin for collecting the droplets as a pool of liquid. The system includes, a first indirect-contact heat exchanger (1st ICHE) immersed in the pool of liquid in the collection basin, the 1st ICHE to heat the liquid process stream by indirect-contact heat exchange cooling the pool of liquid to generate a supercritical process stream; a second indirect-contact heat exchanger (2nd ICHE) in a lower portion of the cooling tower, the 2nd ICHE to heat the supercritical process stream by indirect-contact heat exchange cooling the droplets to generate a gas process stream; and a third indirect-contact heat exchanger (3rd ICHE) in an upper portion of the cooling tower, the 3rd ICHE to heat the gas process stream by indirect-contact heat exchange cooling the droplets.

In some examples, the 3rd ICHE superheats the gas process stream.

In some examples, the 1st ICHE includes of one or more elements selected from the group consisting of tube bundles, pipes, U-tubes, finned tubes, improved tubes, tubes with turbulator inserts, twisted tubes, spirals, and corrugated tubes.

In some examples, the 2nd ICHEs includes one or more elements selected from the group consisting of tube bundles, pipes, U-tubes, finned tubes, improved tubes, tubes with turbulator inserts, twisted tubes, spirals, and corrugated tubes.

In some examples, the 3^{rd} ICHE includes one or more elements selected from the group consisting of tube bundles, pipes, U-tubes, finned tubes, improved tubes, tubes with turbulator inserts, twisted tubes, spirals, and corrugated tubes.

In some examples, the system includes one or more scrapers to scrape ice off of the 1st ICHE, the 2nd ICHE, the 3rd ICHE, or combinations thereof.

In some examples, the system includes one or more heaters to melt ice off of the 1st ICHE, the 2nd ICHE, the 3rd ICHE, or combinations thereof.

In some examples, the system includes an air-separation unit to produce the process stream, the process stream consisting essentially of oxygen for use in an oxy-fuel combustion system; piping to transport cooled liquid from the pool of liquid to the oxy-fuel combustion system to cool one or more unit operations in the oxy-fuel combustion system; and second piping to transport the gas process stream to a combustor of the oxy-fuel combustion system, the gas process stream comprising gaseous oxygen.

In some examples, the system includes a liquified oxygen storage tank to provide the liquid process stream, the liquid process stream consisting essentially of liquid oxygen for use in an oxy-fuel combustion system; piping to transport cooled liquid from the pool of liquid to an oxy-fuel combustion system to cool one or more unit operations in the oxy-fuel combustion system; and second piping to transport the gas process stream to a combustor of the oxy-fuel combustion system, the gas process stream comprising gaseous oxygen.

In some examples, the liquid process stream includes one or more fluids selected from the group consisting of liquid oxygen, liquid nitrogen, natural gas, and liquid argon.

In some examples, the cooling tower is open to allow passage of air through the droplets to further cool the droplets.

In some examples, the system includes one or more blowers to force air through the cooling tower to further cool the droplets.

In some examples, the droplet maker includes a bubble tray to create the droplets.

In some examples, the droplet maker includes an open tray to create the droplets.

In some examples, the droplet maker includes a sprayer to create the droplets.

In some examples, the system includes a second cooling tower, the cooling tower to operate while the second cooling tower de-ices, and the second cooling tower to operate while the cooling tower de-ices.

In some examples, the system includes a plurality of additional cooling towers, wherein the process stream of the cooling tower forms a feed process stream of a next of the plurality of additional cooling towers.

In some examples, the disclosure provides a device for heating a process stream. The device includes a cooling tower with a droplet maker at a top of the cooling tower; a collection basin at a bottom of the cooling tower; a primary indirect-contact heat exchanger (1st ICHE) in the collection basin; a secondary indirect-contact heat exchangers (2nd ICHE) above the collection basin and below the droplet maker; and process stream piping. The process stream piping enters the collection basin and connects to the 1st ICHE, connects the 1st ICHE to the 2nd ICHE; and connects the 2nd ICHE to an exit of the cooling tower.

In some examples, the 1st ICHE includes an element selected from the group consisting of tube bundles, pipes, U-tubes, finned tubes, improved tubes, tubes with turbulator insert, twisted tubes, spirals, and corrugated tubes.

In some examples, the device includes the 2nd ICHE, which may include an element selected from the group consisting of tube bundles, pipes, U-tubes, finned tubes, improved tubes, tubes with turbulator insert, twisted tubes, spirals, and corrugated tubes.

In some examples, the device includes one or more scrapers on the 1st ICHE, the 2nd ICHE, or combinations thereof.

In some examples, the device includes one or more heaters on the 1st ICHE, the 2nd ICHE, or combinations thereof.

In some examples, the cooling tower includes one or more openings to the atmosphere for passively allowing air to cool droplets.

In some examples, the device includes one or more blowers attached to the cooling tower for forcing air across droplets in the cooling tower.

In some examples, the droplet maker includes a bubble tray.

In some examples, the droplet maker includes an open tray.

In some examples, the device includes a pump attached to the collection basin for pumping liquid from the collection basin.

In some examples, the device includes piping connecting the pump to an oxy-fuel combustion plant.

In some examples, the disclosure provides a device for heating a process stream. The device includes a cooling tower including a droplet maker at a top of the cooling tower; a collection basin at a bottom of the cooling tower; a primary indirect-contact heat exchanger (1st ICHE) in the collection basin; two or more secondary indirect-contact heat exchangers (2nd ICHEs) above the collection basin and below the droplet maker; and process stream piping. The process stream piping enters the collection basin and connects to the 1st ICHE; connects the 1st ICHE to a first of the one or more 2nd ICHEs; connects the one or more 2nd ICHEs to each other in series; and connects a last of the 2nd ICHEs to an exit of the cooling tower.

In some examples, the 1st ICHE includes an element selected from the group consisting of tube bundles, pipes, U-tubes, finned tubes, improved tubes, tubes with turbulator insert, twisted tubes, spirals, and corrugated tubes.

In some examples, the two or more 2nd ICHEs include an element selected from the group consisting of tube bundles, pipes, U-tubes, finned tubes, improved tubes, tubes with turbulator insert, twisted tubes, spirals, and corrugated tubes.

In some examples, the device includes one or more scrapers on the 1st ICHE, the two or more 2nd ICHEs, or combinations thereof.

In some examples, the device includes one or more heaters on the 1st ICHE, the two or more 2nd ICHEs, or combinations thereof.

In some examples, the cooling tower includes one or more openings to the atmosphere for passively allowing air to cool droplets.

In some examples, the device includes one or more blowers attached to the cooling tower for forcing air across droplets in the cooling tower.

In some examples, the droplet maker includes a bubble tray.

In some examples, the droplet maker includes an open tray.

In some examples, the device includes a pump attached to the collection basin for pumping liquid from the collection basin.

In some examples, the device includes piping connecting the pump to an oxy-fuel combustion plant.

In some examples, the disclosure provides a method for heating a process stream in a cooling tower. The cooling tower may include a droplet maker for generating droplets and a collection basin for collecting the droplets as a pool of liquid. The method includes transferring heat into a process stream by indirect-contact heat exchange with the pool of liquid through a primary indirect-contact heat exchanger (1st ICHE); and transferring further heat into the process stream by indirect-contact heat exchange with the droplets through one or more secondary indirect-contact heat exchangers (2nd ICHEs).

In some examples, the method includes passing the process stream from the cooling tower to a series of additional cooling towers. Each of the series of additional cooling towers may include additional droplet makers for generating additional droplets and additional collection basins for collecting the additional droplets as additional pools of liquid. The method includes transferring additional heat into the process stream by indirect-contact heat exchange with the additional pools of liquid through additional primary indirect-contact heat exchangers and transferring further additional heat into the process stream by indirect-contact heat exchange with the additional droplets through one or more additional secondary indirect-contact heat exchangers.

In some examples, the process stream consists essentially of liquid nitrogen. In one example, the process stream enters the 1st ICHE as a liquid, the process stream enters the one or more 2nd ICHEs as a supercritical fluid, and the process stream leaves the one or more 2nd ICHEs as a supercritical fluid. In another example, the process stream enters the 1st ICHE as a liquid, the process stream enters the one or more 2nd ICHEs as a gas, and the process stream leaves the one or more 2nd ICHEs as a gas.

In some examples, the process stream consists essentially of liquid oxygen. In one example, the process stream enters the 1st ICHE as a liquid, the process stream enters the one or more 2nd ICHEs as a supercritical fluid, and the process stream leaves the one or more 2nd ICHEs as a supercritical fluid. In another example, the process stream enters the 1st ICHE as a liquid, the process stream enters the one or more 2nd ICHEs as a gas, and the process stream leaves the one or more 2nd ICHEs as a gas.

In some examples, the process stream entering the 1st ICHE consists essentially of liquified natural gas. In one example, the process stream enters the 1st ICHE as a liquid, the process stream enters the one or more 2nd ICHEs as a gas, and the process stream leaves the one or more 2nd ICHEs as a gas. In another example, the process stream enters the 1st ICHE as a liquid, the process stream enters the one or more 2nd ICHEs as a supercritical fluid, and the process stream leaves the one or more 2nd ICHEs as a supercritical fluid.

In some examples, the process stream entering the 1st ICHE consists of natural gas.

In some examples, the method includes passing air passively through the cooling tower and cooling the droplets against the air.

In some examples, the method includes passing air actively through the cooling tower and cooling the droplets against the air.

In some examples, the method includes combusting the process stream leaving the one or more 2nd ICHEs in a combustor of an oxy-fuel combustion plant.

In some examples, the method includes cooling unit operations in an oxy-fuel combustion plant with liquid from the pool of liquid.

In some examples, the method includes creating a liquified gas product stream in an air-separation unit, wherein the liquified gas product stream is the process stream entering the 1st ICHE.

In some examples, the process stream entering the 1st ICHE consists essentially of a gas.

In some examples, the fluid process stream entering the 1st ICHE consists essentially of a liquid.

In some examples, the fluid process stream entering the 1st ICHE consists essentially of a supercritical fluid.

In some examples, the disclosure provides a method for heating a process stream in an alpha cooling tower and a beta cooling tower. The alpha cooling tower includes a first droplet maker for generating first droplets and a first collection basin for collecting the first droplets as a first pool of liquid. The beta cooling tower includes a second droplet maker for generating second droplets and a second collection basin for collecting the second droplets as a second pool of liquid. The method includes: 1) Transferring heat into the process stream by indirect-contact heat exchange with the first pool of liquid through an alpha primary indirect-contact heat exchanger (alpha 1st ICHE). 2) Transferring further heat into the process stream by indirect-contact heat exchange with the first droplets through one or more alpha secondary indirect-contact heat exchangers (alpha 2nd ICHEs). 3) Shutting down the alpha cooling tower after starting the beta cooling tower. During shutdown of the alpha cooling tower, conducting steps 4, 5, and 6. 4) Removing first ice from the alpha 1st ICHE and the one or more alpha 2nd ICHEs. 5) Transferring heat into the process stream by indirect-contact heat exchange with the second pool of liquid through a beta first indirect-contact heat exchanger (beta 1st ICHE). 6) Transferring further heat into the process stream by indirect-contact heat exchange with the second droplets through one or more beta secondary indirect-contact heat exchangers (beta 2nd ICHEs). 7) Shutting down the beta cooling tower after starting the alpha cooling tower. During shutdown of the beta cooling tower, conducting operations 8, 1, and 2. 8) Removing second ice from the beta 1st ICHE and the one or more beta 2nd ICHEs.

In some examples, the process stream consists essentially of liquid nitrogen. In one example, the process stream enters the alpha 1st ICHE or the beta 1st ICHE as a liquid, the process stream enters the one or more alpha 2nd ICHEs or the one or more beta 2nd ICHEs as a supercritical fluid, and the process stream leaves the one or more alpha 2nd ICHEs or the one or more beta 2nd ICHEs as a supercritical fluid. In another example, the process stream enters the alpha 1st ICHE or the beta 1st ICHE as a liquid, the process stream enters the one or more alpha 2nd ICHEs or the one or more beta 2nd ICHEs as a gas, and the process stream leaves the one or more alpha 2nd ICHEs or the one or more beta 2nd ICHEs as a gas.

In some examples, the process stream consists essentially of liquid oxygen. In one example, the process stream enters the alpha 1st ICHE or the beta 1st ICHE as a liquid, the process stream enters the one or more alpha 2nd ICHEs or the one or more beta 2nd ICHEs as a supercritical fluid, and the process stream leaves the one or more alpha 2nd ICHEs or the one or more beta 2nd ICHEs as a supercritical fluid. In another example, the process stream enters the alpha 1st ICHE or the beta 1st ICHE as a liquid, the process stream enters the one or more alpha 2nd ICHEs or the one or more beta 2nd ICHEs as a gas, and the process stream leaves the one or more alpha 2nd ICHEs or the one or more beta 2nd ICHEs as a gas.

In some examples, the process stream entering the alpha 1st ICHE or beta 1st ICHE consists essentially of liquified natural gas. In one example, the process stream enters the alpha 1st ICHE or the beta 1st ICHE as a liquid, the process stream enters the one or more alpha 2nd ICHEs or the one or more beta 2nd ICHEs as a gas, and the process stream leaves the one or more alpha 2nd ICHEs or the one or more beta 2nd ICHEs as a gas. In another example, the process stream enters the alpha 1st ICHE or the beta 1st ICHE as a liquid, the process stream enters the one or more alpha 2nd ICHEs or the one or more beta 2nd ICHEs as a supercritical fluid, and the process stream leaves the one or more alpha 2nd ICHEs or the one or more beta 2nd ICHEs as a supercritical fluid.

In some examples, the process stream entering the alpha 1st ICHE or the beta 1st ICHE consists of natural gas.

In some examples, the method includes passing air passively through the alpha or beta cooling towers and cooling the first or second droplets against the air.

In some examples, the method includes passing air actively through the alpha or beta cooling towers and cooling the first or second droplets against the air.

In some examples, the method includes combusting the process stream leaving the one or more alpha 2nd ICHEs or the one or more beta 2nd ICHEs in a combustor of an oxy-fuel combustion plant.

In some examples, the method includes cooling unit operations in an oxy-fuel combustion plant with liquid from the first or second pools of liquid.

In some examples, the method includes creating a liquified gas product stream in an air-separation unit, wherein the liquified gas product stream is the process stream entering the alpha or beta 1st ICHE.

In some examples, the process stream entering the alpha 1st ICHE or the beta 1st ICHE comprises a gas.

In some examples, the fluid process stream entering the alpha 1st ICHE or the beta 1st ICHE comprises a liquid.

In some examples, the fluid process stream entering the alpha 1st ICHE or the beta 1st ICHE comprises a supercritical fluid.

Further examples are provided in the drawings, detailed description, and claims.

### BRIEF DESCRIPTION OF DRAWINGS

The following drawings are provided to illustrate certain embodiments described herein. The drawings are merely illustrative and are not intended to limit the scope of the claims and are not intended to show every potential feature or embodiment that is claimed. The drawings are not necessarily drawn to scale; in some instances, certain elements of the drawing may be enlarged with respect to other elements of the drawing for purposes of illustration.

FIG. 1 is a process flow diagram showing a cooling tower with internal heat exchangers.

FIG. 2 is a process flow diagram showing a cooling tower with internal heat exchangers.

FIG. 3 is a system diagram showing a series of cooling towers with internal heat exchangers.

FIG. 4 is a system diagram showing a set of parallel cooling towers with internal heat exchangers.

FIG. 5 is a cutaway front, top, left isometric diagram showing a cooling tower with internal heat exchangers.

FIG. 6 is a cutaway front, top, left isometric diagram showing a cooling tower with internal heat exchangers.

FIG. 7 is a block diagram showing a method for operating a cooling tower with internal heat exchangers.

FIG. 8 is a block diagram showing a method for operating a cooling tower with internal heat exchangers.

### DETAILED DESCRIPTION

The following description recites various aspects and embodiments of the subject matter disclosed herein. No particular embodiment is intended to define the scope of the present subject matter. Rather, the embodiments provide non-limiting examples of various compositions, and methods that are included within the scope of the claimed subject matter. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “about” means within ±10% of the stated value, e.g., within ±5% of the stated value, or within ±2% of the stated value.

Conventional heating methods used for cryogenics and cold fluids include vaporizers (ambient or fan assisted, often with electrical heater embedded) and hot water bath (steam, electrical, and gas fired). The present disclosure describes use of very low grade waste heat collected by the cooling tower from various devices and equipment (e.g., pumps, compressors, heat exchangers, etc.) to provide necessary heat energy to preheat and/or vaporize process streams. The disclosure provides passive heating for cold or cryogenic streams and cooling for the cooling tower water as well without involving any active energy consuming equipment and devices. For example, the oxygen supply from a cryogenic reservoir is at about −183 °C at about 1 bar and needs to be preheated and pressurized before oxy-combustion processes to about 15-20 °C at 110 bar. Similarly, the natural gas supply temperature also requires pre-heating to 15-20 °C for oxy-combustion processes from the source at about −5 to −10 °C. Conventional processes use gas fired heaters or electric heaters whereas the current disclosure uses the process water available in the cooling tower as a heating medium.

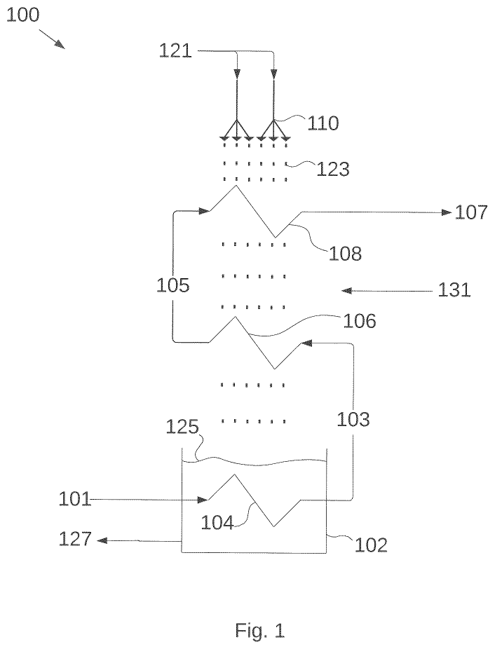

Now referring to FIG. 1, FIG. 1 is a process flow diagram showing a cooling tower with internal heat exchangers that may be used in some examples provided herein. This example is purely illustrative, and multiple other examples are envisioned or may be readily envisioned without undue experimentation.

In some examples, system 100 includes a cooling tower with internal heat exchangers, one or more immersed in the liquid at the bottom of the cooling tower, and one or more in the air space making contact with droplets. In the nonlimiting configuration illustrated in FIG. 1, system 100, a cooling tower, includes a collection basin 102, a primary indirect-contact heat exchanger (1^{st} ICHE) 104, a secondary indirect-contact heat exchanger (2^{nd} ICHE) 106, a tertiary indirect-contact heat exchanger (3^{rd} ICHE) 108, and sprayers 110. The 3^{rd} ICHE 108 is above the 2^{nd} ICHE 106.

Process stream 101 enters the cooling tower 100 and passes into the collection basin 102 and through 1^{st} ICHE 104 where it is heated against the pool of liquid 125 through the walls of the 1^{st} ICHE 104. The process stream 103 then passes through 2^{nd} ICHE 106 where it is heated against falling droplets 123 through the walls of the 2^{nd} ICHE 106. The process stream 105 then passes through 3^{rd} ICHE 108 where it is heated against falling droplets 123 through the walls of the 3^{rd} ICHE 108. The process stream 107 then leaves the cooling tower.

Sprayer 110 receives liquid stream 121 and creates droplets 123, which fall and are cooled against the 3^{rd} ICHE 108 and then against the 2^{nd} ICHE 106. The droplets 123 then fall into collection basin 102 to form the pool of liquid 125. The pool of liquid 125 is further cooled and then removed from the collection basin as stream 127. In some examples, the pool of liquid may be recirculated to provide cooling duty for other devices, such as pumps, compressors, heat exchangers, or similar.

In the present example, the sides of the cooling tower 100 are open, allowing passage of air through the droplets 123 to further cool the droplets.

In this example, the process stream 101 may be, may include, or may consist essentially of, oxygen, nitrogen, natural gas, argon, or a combination thereof. The process stream may be a liquid, a gas, or a supercritical fluid upon entry into the cooling tower 100.

In one example where oxygen is process stream 101, and the oxygen enters as a liquid, process stream 103 is a supercritical fluid, and process stream 105 is a gas. In another example, stream 101 is a liquid, stream 103 is a supercritical fluid, and stream 105 is a supercritical fluid.

In one example where nitrogen is process stream 101, and the nitrogen enters as a liquid, process stream 103 is a supercritical fluid, and process stream 105 is a gas. In another example, stream 101 is a liquid, stream 103 is a supercritical fluid, and stream 105 is a supercritical fluid.

In some examples, 3^{rd} ICHE 108 superheats gas stream 105.

In some examples, the 1^{st}, 2^{nd}, 3^{rd}, or any number of exchangers may include tube bundles, pipes, U-tubes, finned tubes, improved tubes, tubes with turbulator inserts, twisted tubes, spirals, or corrugated tubes.

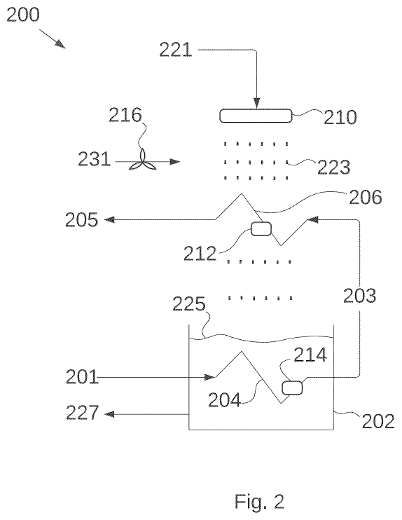

Now referring to FIG. 2, FIG. 2 is a process flow diagram showing a cooling tower with internal heat exchangers that may be used in some examples provided herein. This example is purely illustrative, and multiple other examples are envisioned or may be readily envisioned without undue experimentation.

In some examples, system 200 includes a cooling tower with internal heat exchangers, one or more immersed in the liquid at the bottom of the cooling tower, and one or more in the air space making contact with droplets. In the nonlimiting configuration illustrated in FIG. 2, system 200, a cooling tower, includes a collection basin 202, a primary indirect-contact heat exchanger (1^{st} ICHE) 104, a secondary indirect-contact heat exchanger (2^{nd} ICHE) 206, and tray 210.

Process stream 201 enters the cooling tower 200 and passes into the collection basin 202 and through 1^{st} ICHE 204 where it is heated against the pool of liquid 225 through the walls of the 1^{st} ICHE 204. The process stream 203 then passes through 2^{nd} ICHE 206 where it is heated against falling droplets 223 through the walls of the 2^{nd} ICHE 206. The process stream 205 then leaves the cooling tower.

Tray 210 (e.g., a bubble tray or an open tray) receives liquid stream 221 and creates droplets 223, which fall and are cooled against the 2^{nd} ICHE 206. The droplets 223 then fall into collection basin 202 to form the pool of liquid 225. The pool of liquid 225 is further cooled and then removed from the collection basin as stream 227.

In this example, a heater or an ice scraper 214 is used to remove any deposited ice from 1^{st} ICHE 204. A heater or an ice scraper 212 is used to remove any deposited ice from 2^{nd} ICHE 206.

In this example, a blower 216 blows forced air 231 into the cooling tower 200 and further cools droplets 223.

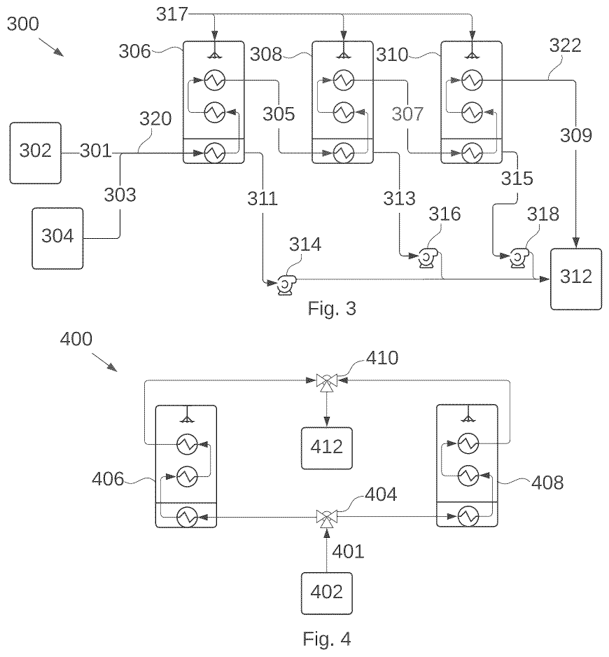

Now referring to FIG. 3, FIG. 3 is a system diagram showing a series of cooling towers with internal heat exchangers that may be used in some examples provided herein. This example is purely illustrative, and multiple other examples are envisioned or may be readily envisioned without undue experimentation.

In some examples, system 300 includes a series of cooling towers with internal heat exchangers used to warm an incoming liquid oxygen stream and pass the warmed stream to an oxy-fuel combustion plant for use as oxidant. In the nonlimiting configuration illustrated in FIG. 3, system 300 includes an air-separation unit (ASU) 302 or a liquid oxygen storage vessel 304, a first cooling tower 306, a second cooling tower 308, a third cooling tower 310, an oxy-fuel combustion plant 312, a first pump 314, a second pump 316, a third pump 318, piping 320, and piping 322. The first cooling tower 306, the second cooling tower 308, and the third cooling tower 310 may be cooling tower 100 from FIG. 1, though any example of the cooling tower of the present disclosure would be acceptable.

Liquid oxygen 301 or liquid oxygen 303 is sent through piping 320 from the ASU 302 or the liquid oxygen vessel 304, respectively, to the first cooling tower 306. The oxygen stream is warmed and passed as stream 305 to second cooling tower 308, where it is further warmed and passed as stream 307 to third cooling tower 310, resulting in warmed oxygen stream 309. The warmed oxygen stream is passed via piping 322 to the oxy-fuel combustion plant 312 which uses the oxygen as the oxidant for the plant's combustor.

Warm water stream 317 is passed through sprayers into cooling towers 306, 308, and 310. The droplets warm the process stream in each of the cooling towers' 2^{nd} and 3^{rd} ICHEs and collects as a pool of liquid in each of the collection basins. The pool of liquid warms the process streams, generating cold water streams 311, 313, and 315 which are pumped by first pump 314, second pump 316, and third pump 318, respectively, to the oxy-fuel combustion plant 312 where the streams 311, 313, and 315 are used as cooling water for unit operations of the plant 312.

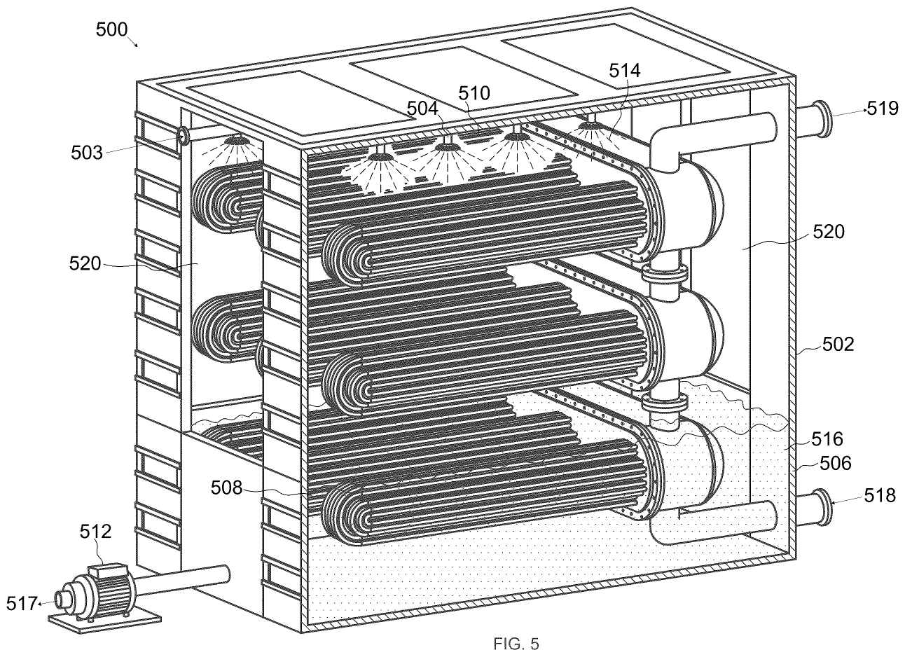

Now referring to FIG. 4, FIG. 4 is a system diagram showing a set of parallel cooling towers with internal heat exchangers that may be used in some examples provided herein. This example is purely illustrative, and multiple other examples are envisioned or may be readily envisioned without undue experimentation.

In some examples, system 400 includes a set of cooling towers used to warm an incoming liquified gas and deliver it to a consumer of the gas. The system 400 includes a liquified gas storage tank 402, a three-way valve 404, a first cooling tower 406, a second cooling tower 408, a three-way valve 410, and a gas consuming plant 412.

The cooling towers 406 and 408 used may be those of FIG. 1, though any example of the cooling tower of the present disclosure would be acceptable.

The liquified gas stream 401 passes from the storage tank 402 and through three-way valve 404, which sends it either to first cooling tower 406 or second cooling tower 408. Initially, the valve 404 sends stream 401 to first cooling tower 406 where the stream 401 is heated and passed through three-way valve 410 and on to plant 412. Over time, the exterior of the process piping inside first cooling tower 406 freezes over, insulating the exchangers and preventing warming of the process stream. When freezing reaches a critical point where efficiency drops below a desired threshold, the three-way valve 404 switches the stream 401 to pass through second cooling tower 408 and on through three-way valve 410 to plant 412. While the second cooling tower 408 is in operation, the first cooling tower 406 is allowed to de-ice, either passively by water passing through the cooling tower and melting the ice, or actively by either scraping the ice off with a scraper or by heaters attached to the heat exchangers to melt the ice. When the first cooling tower 406 is in operation, the second cooling tower 408 receives the same de-icing treatment.

FIG. 5 is a cutaway front, top, left isometric diagram showing a cooling tower with internal heat exchangers that may be used in some examples provided herein. This example is purely illustrative, and multiple other examples are envisioned or may be readily envisioned without undue experimentation.

In some examples, device 500 includes a cooling tower with heat exchangers. The cooling tower 500 includes the cooling tower structure 502, inlet water 503, sprayers 504, collection basin 506, primary heat exchangers 508, secondary heat exchangers 510, pump 512, droplets 514, pool of water 516, discharge water 517, inlet process fluid 518, outlet process fluid 519, and cooling tower openings 520. The sprayers 504 spray inlet water 503 as water droplets 514 into the interior of the cooling tower structure 502 where they fall over the secondary heat exchangers 510 and into the pool of water 516. The pool of water 516 heats the process fluid 518 in the primary heat exchangers 508, which passes then to the secondary heat exchangers 510. The pool of water 516, now cold, is pumped by pump 512 as discharge water 517 to other unit operations for use as a cooling water. The cooling tower openings 520 allow air to pass through the cooling tower structure 502, further cooling the droplets 514, and passing out an opposite opening 520.

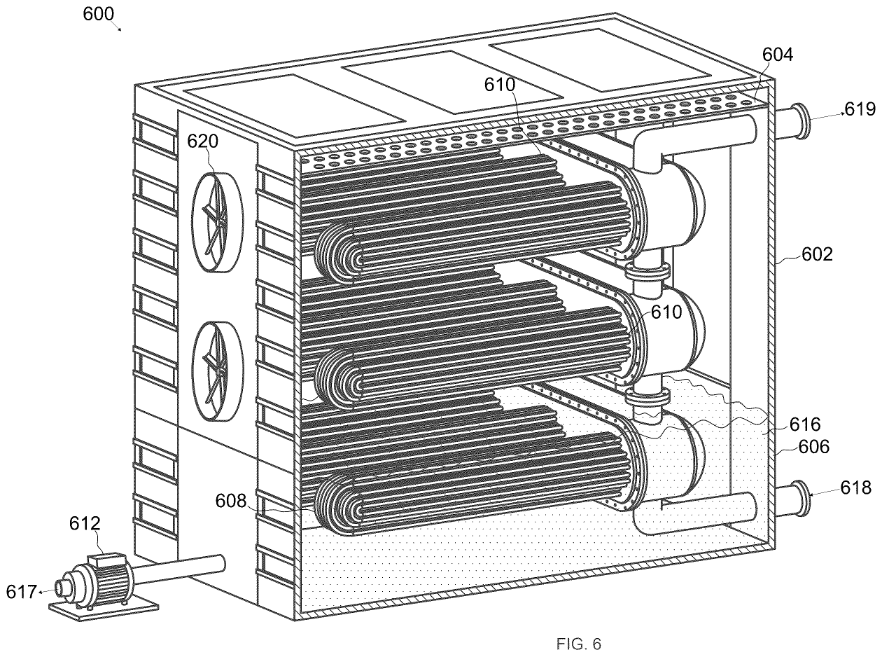

FIG. 6 is a cutaway front, top, left isometric diagram showing a cooling tower with internal heat exchangers that may be used in some examples provided herein. This example is purely illustrative, and multiple other examples are envisioned or may be readily envisioned without undue experimentation.

In some examples, device 600 includes a cooling tower with heat exchangers. The cooling tower 600 includes the cooling tower structure 602, open tray 604, collection basin 606, primary heat exchangers 608, secondary heat exchangers 610, pump 612, pool of water 616, discharge water 617, inlet process fluid 618, outlet process fluid 619, and blowers 620. The open tray 604 turns inlet water into water droplets which fall through the interior of the cooling tower structure 602 where they fall over the secondary heat exchangers 610 and into the pool of water 616. The pool of water 616 heats the process fluid 618 in the primary heat exchangers 608, which passes then to the secondary heat exchangers 610. The pool of water 616, now cold, is pumped by pump 612 as discharge water 617 to other unit operations for use as a cooling water. The blowers 620 blow air through the cooling tower structure 602, further cooling the droplets.

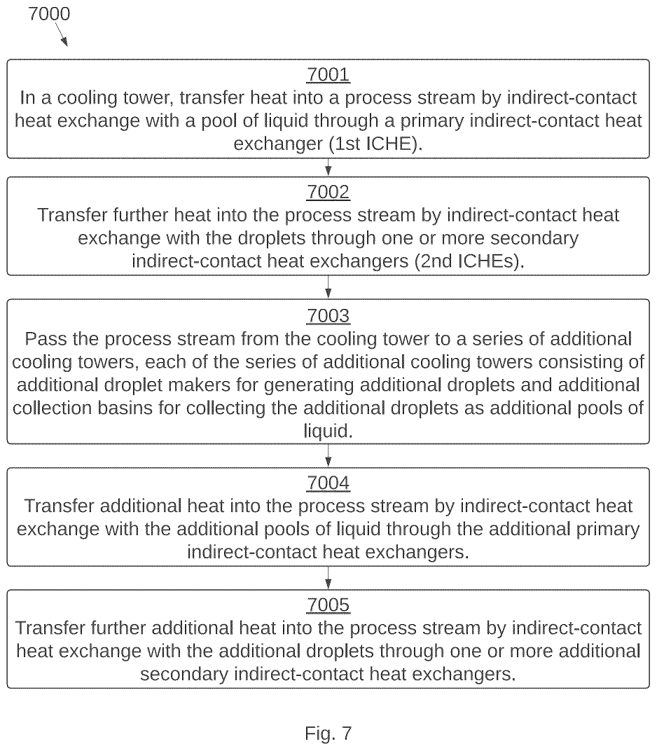

Illustratively, FIG. 7 is a block diagram showing an example method 7000 for operating a cooling tower with internal heat exchangers that may be used in some examples provided herein. The method warms a process stream and cools a liquid stream, in many examples, water. While method 3000 optionally may be implemented using system 100, 200, 300, or 400, and devices 500 or 600, it will be appreciated that any other suitable combination of components may be used to implement method 7000.

Method 7000 illustrated in FIG. 7 may include transferring heat into a process stream by indirect-contact heat exchange with a pool of liquid in a cooling tower through a primary indirect-contact heat exchanger (1^{st} ICHE) (operation 7001). For example, in a manner such as described above with reference to FIG. 1, process stream 101 is warmed in 1^{st} ICHE 104 against the pool of liquid 125.

Referring again to FIG. 7, method 7000 may also include transferring further heat into the process stream by indirect-contact heat exchange with the droplets through one or more secondary indirect-contact heat exchangers (2^{nd} ICHEs) (operation 7002). For example, in a manner such as described above with reference to FIG. 1, the process stream 103 passes through 2^{nd} ICHE 106 and is heated against falling droplets 123 and then through 3^{rd} ICHE 108 against further droplets 123.

Referring again to FIG. 7, method 7000 may also include passing the process stream from the cooling tower to a series of additional cooling towers, each of the series of additional cooling towers including additional droplet makers for generating additional droplets and additional collection basins for collecting the additional droplets as additional pools of liquid (operation 7003). For example, in a manner such as described above with reference to FIG. 3 regarding additional cooling towers 308 and 310, each having the additional collection basins and the additional pools of liquid.

Referring again to FIG. 7, method 7000 may also include transferring additional heat into a process stream by indirect-contact heat exchange with additional pools of liquid in additional cooling tower through additional primary indirect-contact heat exchangers (operation 7004). For example, in a manner such as described above with reference to FIG. 3, process stream 305 is warmed in an additional first exchanger in cooling tower 308 against the pool of liquid and process stream 307 is warmed in an additional first exchanger in cooling tower 310 against the pool of fluid.

Referring again to FIG. 7, method 7000 may also include transferring further additional heat into the process stream by indirect-contact heat exchange with the additional droplets through one or more additional secondary indirect-contact heat exchangers (operation 7005). For example, in a manner such as described above with reference to FIG. 3, the process stream 305 passes through additional secondary heat exchangers in cooling tower 308 and is heated against falling droplets and then process stream 307 passes through additional secondary heat exchangers in cooling tower 310 and is heated against falling droplets.

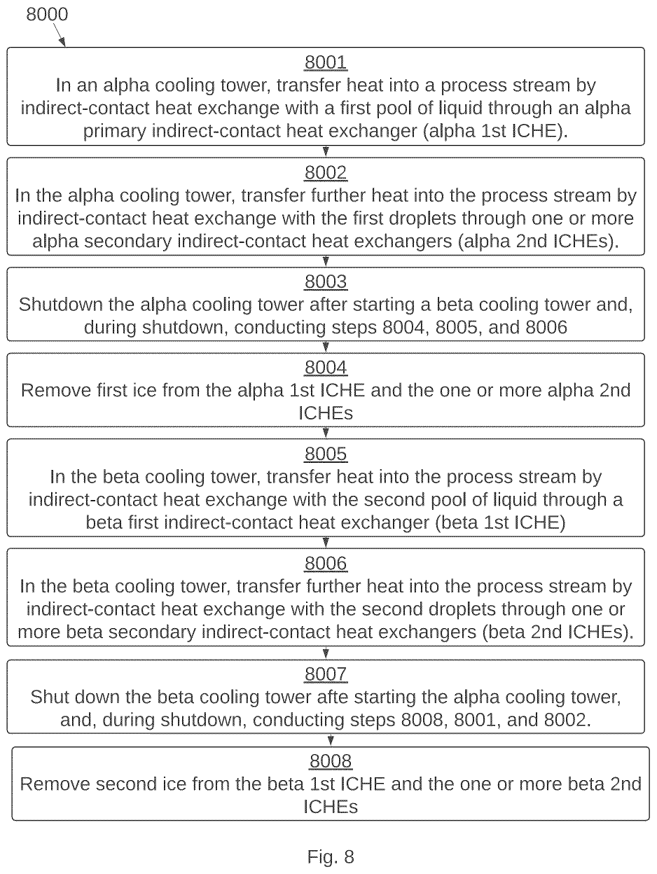

Method 8000 illustrated in FIG. 8 may include, in an alpha cooling tower, transferring heat into a process stream by indirect-contact heat exchange with a first pool of liquid in the alpha cooling tower through an alpha primary indirect-contact heat exchanger (alpha 1^{st} ICHE) (operation 8001). For example, in a manner such as described above with reference to FIG. 4, process stream 401 is warmed in the alpha 1^{st} ICHE of the alpha cooling tower 406 against the first pool of liquid.

Referring again to FIG. 8, method 8000 may also include, in the alpha cooling tower, transferring further heat into the process stream by indirect-contact heat exchange with the first droplets through one or more alpha secondary indirect-contact heat exchangers (alpha 2^{nd} ICHEs) (operation 8002). For example, in a manner such as described above with reference to FIG. 4, the process stream 401 passes through the alpha 2^{nd} ICHEs in the alpha cooling tower 406 and is heated against falling first droplets.

Referring again to FIG. 8, method 8000 may also include shutting down the alpha cooling tower after starting a beta cooling tower and, during shutdown, conducting steps 8004, 8005, and 8006 (operation 8003). For example, in a manner such as described above with reference to FIG. 4, the alpha cooling tower 406 may shut down after the beta cooling tower 408 is started.

Referring again to FIG. 8, method 8000 may also include removing first ice from the alpha 1^{st} ICHE and the one or more alpha 2^{nd} ICHEs (operation 8004). For example, in a manner such as described above with reference to FIG. 2, the heaters or scrapers 212 and 214 may be activated and used to remove ice from the alpha exchangers.

Method 8000 illustrated in FIG. 8 may include, in a beta cooling tower, transferring heat into a process stream by indirect-contact heat exchange with a second pool of liquid in the beta cooling tower through a beta primary indirect-contact heat exchanger (beta 1^{st} ICHE) (operation 8005). For example, in a manner such as described above with reference to FIG. 4, process stream 401 is warmed in the beta 1^{st} ICHE of the beta cooling tower 408 against the second pool of liquid.

Referring again to FIG. 8, method 8000 may also include, in the beta cooling tower, transferring further heat into the process stream by indirect-contact heat exchange with the second droplets through one or more beta secondary indirect-contact heat exchangers (beta 2^{nd} ICHEs) (operation 8006). For example, in a manner such as described above with reference to FIG. 4, the process stream 401 passes through the beta 2^{nd} ICHEs in the beta cooling tower 408 and is heated against falling second droplets.

Referring again to FIG. 8, method 8000 may also include shutting down the beta cooling tower after starting the alpha cooling tower and, during shutdown, conducting steps 8008, 8001, and 8002 (operation 8007). For example, in a manner such as described above with reference to FIG. 4, the beta cooling tower 408 may shut down after the alpha cooling tower 406 is started.

Referring again to FIG. 8, method 8000 may also include removing second ice from the beta 1^{st} ICHE and the one or more beta 2^{nd} ICHEs (operation 8008). For example, in a manner such as described above with reference to FIG. 2, the heaters or scrapers 212 and 214 may be activated and used to remove ice from the beta exchangers.

A controller may be used in any of the examples shown above in order to both receive data from instrumentation and to send the instructions required to do the steps listed above. The controller may include any suitable combination of hardware (e.g., application specific integrated circuit (ASIC), field programmable gate array (FPGA), central processing unit (CPU), graphics process unit (GPU) or the like) and software (e.g., instructions causing the hardware to implement the functionality described herein). The instructions may be stored on a non-transitory computer-readable medium storing instructions to cause the processor to perform the steps of the present system. The circuitry between the controller and the instrumentation and equipment may be implemented using any suitable combination of hardware and software.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

1. A system for heating a process stream in a cooling tower, the cooling tower comprising a droplet maker for generating droplets and a collection basin for collecting the droplets as a pool of liquid, the system comprising:
a primary indirect-contact heat exchanger (1^{st} ICHE) immersed in the pool of liquid in the collection basin, the 1^{st} ICHE to heat the process stream by indirect-contact heat exchange cooling the pool of liquid; and
one or more secondary indirect-contact heat exchangers (2^{nd} ICHEs) in the cooling tower, the one or more 2^{nd} ICHEs to further heat the process stream by indirect-contact heat exchange cooling the droplets.

2. The system of claim 1, wherein the process stream comprises one or more fluids selected from the group consisting of oxygen, nitrogen, natural gas, and argon.

3. The system of claim 1, wherein the 1^{st} ICHE or the one or more 2nd ICHEs comprise one or more elements selected from the group consisting of tube bundles, pipes, U-tubes, finned tubes, improved tubes, tubes with turbulator insert, twisted tubes, spirals, and corrugated tubes.

4. (canceled)

5. The system of claim 1, further comprising one or more scrapers to scrape or one or more heaters to melt ice off of the 1^{st} ICHE, the one or more 2^{nd} ICHEs, or combinations thereof.

6. (canceled)

7. The system of claim 1, further comprising:
an air-separation unit to produce the process stream or a liquified oxygen storage tank to provide the process stream, the process stream comprising oxygen or liquid oxygen for use in an oxy-fuel combustion system;
piping to transport cooled liquid from the pool of liquid to the oxy-fuel combustion system to cool one or more unit operations in the oxy-fuel combustion system; and
second piping to transport the process stream to a combustor of the oxy-fuel combustion system.

8. (canceled)

9. The system of claim 1, wherein the cooling tower is open to allow passage of air through the droplets to further cool the droplets or the system further comprises one or more blowers to force air through the cooling tower to further cool the droplets.

10. (canceled)

11. The system of claim 1, the droplet maker comprising a bubble tray to create the droplets, an open tray to create the droplets, or a sprayer to create the droplets.

12. (canceled)

13. (canceled)

14. The system of claim 1, further comprising a second cooling tower, the cooling tower to operate while the second cooling tower de-ices, and the second cooling tower to operate while the cooling tower de-ices.

15. The system of claim 1, further comprising a plurality of additional cooling towers, wherein the process stream of the cooling tower forms a fluid process stream of a next cooling tower of the plurality of additional cooling towers.

16. The system of claim 1, wherein:
the process stream is a liquid process stream;
the 1^{st} ICHE is a first indirect-contact heat exchanger to heat the liquid process stream by indirect-contact heat exchange cooling the pool of liquid to generate a supercritical process stream; and
the one or more 2^{nd} ICHEs comprise a second indirect-contact heat exchanger (2^{nd} ICHE) and a third indirect-contact heat exchanger (3rd ICHE), the 2^{nd} ICHE in a lower portion of the cooling tower, the 2^{nd} ICHE to heat the supercritical process stream by indirect-contact heat exchange cooling the droplets to generate a gas process stream, the 3rd ICHE in an upper portion of the cooling tower, the 3rd ICHE to heat the gas process stream by indirect-contact heat exchange cooling the droplets.

17. The system of claim 16, wherein the 3^{rd} ICHE superheats the gas process stream.

18. (canceled)

19. (canceled)

20. (canceled)

21. (canceled)

22. (canceled)

23. The system of claim 16,
wherein the gas process stream comprises gaseous oxygen.

24. (canceled)

25. (canceled)

26. (canceled)

27. (canceled)

28. (canceled)

29. (canceled)

30. (canceled)

31. (canceled)

32. (canceled)

33. A device for heating a process stream, the device comprising:
a cooling tower comprising:
a droplet maker at a top of the cooling tower; and
a collection basin at a bottom of the cooling tower;
a primary indirect-contact heat exchanger (1^{st} ICHE) in the collection basin;
one or more secondary indirect-contact heat exchangers (2^{nd} ICHEs) above the collection basin and below the droplet maker; and
process stream piping:
entering the collection basin and connecting to the 1^{st} ICHE;
connecting the 1^{st} ICHE to a first of the one or more 2^{nd} ICHEs;
connecting a last of the one or more 2^{nd} ICHEs to an exit of the cooling tower; and
where the one or more 2^{nd} ICHEs comprise two or more 2^{nd} ICHEs, connecting the two or more 2^{nd} ICHEs to each other in series.

34. The device of claim 33, wherein the 1^{st} ICHE or the one or more 2^{nd} ICHEs comprise an element selected from the group consisting of tube bundles, pipes, U-tubes, finned tubes, improved tubes, tubes with turbulator insert, twisted tubes, spirals, and corrugated tubes.

35. (canceled)

36. The device of claim 33, further comprising one or more scrapers or one or more heaters on the 1^{st} ICHE, the one or more 2^{nd} ICHEs, or combinations thereof.

37. (canceled)

38. The device of claim 33, wherein the cooling tower comprises one or more openings to the atmosphere for passively allowing air to cool droplets or the device further comprises one or more blowers attached to the cooling tower for forcing air across droplets in the cooling tower.

39. (canceled)

40. The device of claim 33, wherein the droplet maker comprises a bubble tray or an open tray.

41. (canceled)

42. The device of claim 33, further comprising a pump attached to the collection basin for pumping liquid from the collection basin.

43. The device of claim 42, further comprising piping connecting the pump to an oxy-fuel combustion plant.

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. A method for heating a process stream in a cooling tower, the cooling tower comprising a droplet maker for generating droplets and a collection basin for collecting the droplets as a pool of liquid, the method comprising:
transferring heat into the process stream by indirect-contact heat exchange with the pool of liquid through a primary indirect-contact heat exchanger (1^{st} ICHE); and
transferring further heat into the process stream by indirect-contact heat exchange with the droplets through one or more secondary indirect-contact heat exchangers (2^{nd} ICHEs).

56. The method of claim 55, further comprising:
passing the process stream from the cooling tower to a series of additional cooling towers, each of the series of additional cooling towers comprising additional droplet makers for generating additional droplets and additional collection basins for collecting the additional droplets as additional pools of liquid;
transferring additional heat into the process stream by indirect-contact heat exchange with the additional pools of liquid through additional primary indirect-contact heat exchangers; and
transferring further additional heat into the process stream by indirect-contact heat exchange with the additional droplets through one or more additional secondary indirect-contact heat exchangers.

57. The method of claim 55, wherein the process stream comprises liquid nitrogen, liquid oxygen, liquified natural gas, or natural gas.

58. The method of claim 57, wherein the process stream enters the 1^{st} ICHE as a liquid, the process stream enters the one or more 2^{nd} ICHEs as a supercritical fluid, and the process stream leaves the one or more 2^{nd} ICHEs as a supercritical fluid.

59. The method of claim 57, wherein the process stream enters the 1^{st} ICHE as a liquid, the process stream enters the one or more 2^{nd} ICHEs as a gas, and the process stream leaves the one or more 2^{nd} ICHEs as a gas.

60. (canceled)

61. (canceled)

62. (canceled)

63. (canceled)

64. (canceled)

65. (canceled)

66. (canceled)

67. The method of claim 55, further comprising passing air passively or actively through the cooling tower and cooling the droplets against the air.

68. (canceled)

69. The method of claim 55, further comprising combusting the process stream leaving the one or more 2^{nd} ICHEs in a combustor of an oxy-fuel combustion plant.

70. The method of claim 55, further comprising cooling unit operations in an oxy-fuel combustion plant with liquid from the pool of liquid.

71. The method of claim 55, further comprising creating a liquified gas product stream in an air-separation unit, wherein the liquified gas product stream is the process stream entering the 1^{st} ICHE.

72. The method of claim 55, wherein the process stream entering the 1^{st} ICHE comprises a gas, a liquid, or a supercritical fluid.

73. (canceled)

74. (canceled)

75. A method for heating a process stream in an alpha cooling tower and a beta cooling tower, the alpha cooling tower comprising a first droplet maker for generating first droplets and a first collection basin for collecting the first droplets as a first pool of liquid, and the beta cooling tower comprising a second droplet maker for generating second droplets and a second collection basin for collecting the second droplets as a second pool of liquid, the method comprising:
1) transferring heat into the process stream by indirect-contact heat exchange with the first pool of liquid through an alpha primary indirect-contact heat exchanger (alpha 1^{st} ICHE);
2) transferring further heat into the process stream by indirect-contact heat exchange with the first droplets through one or more alpha secondary indirect-contact heat exchangers (alpha 2^{nd} ICHEs);
3) shutting down the alpha cooling tower after starting the beta cooling tower; and
during shutdown of the alpha cooling tower, conducting steps 4, 5, and 6;
4) removing first ice from the alpha 1^{st} ICHE and the one or more alpha 2^{nd} ICHEs;
5) transferring heat into the process stream by indirect-contact heat exchange with the second pool of liquid through a beta first indirect-contact heat exchanger (beta 1^{st} ICHE);
6) transferring further heat into the process stream by indirect-contact heat exchange with the second droplets through one or more beta secondary indirect-contact heat exchangers (beta 2^{nd} ICHEs);
7) shutting down the beta cooling tower after starting the alpha cooling tower; and
during shutdown of the beta cooling tower, conducting operations 8, 1, and 2; and
8) removing second ice from the beta 1^{st} ICHE and the one or more beta 2^{nd} ICHEs.

76. The method of claim 75, wherein the process stream comprises liquid nitrogen, liquid oxygen, liquified natural gas, or natural gas.

77. The method of claim 75, wherein the process stream enters the alpha 1^{st} ICHE or the beta 1^{st} ICHE as a liquid, the process stream enters the one or more alpha 2^{nd} ICHEs or the one or more beta 2^{nd} ICHEs as a supercritical fluid, and the process stream leaves the one or more alpha 2^{nd} ICHEs or the one or more beta 2^{nd} ICHEs as a supercritical fluid.

78. The method of claim 75, wherein the process stream enters the alpha 1^{st} ICHE or the beta 1^{st} ICHE as a liquid, the process stream enters the one or more alpha 2^{nd} ICHEs or the one or more beta 2^{nd} ICHEs as a gas, and the process stream leaves the one or more alpha 2^{nd} ICHEs or the one or more beta 2^{nd} ICHEs as a gas.

79. (canceled)

80. (canceled)

81. (canceled)

82. (canceled)

83. (canceled)

84. (canceled)

85. (canceled)

86. The method of claim 75, further comprising passing air passively or actively through the alpha or beta cooling towers and cooling the first or second droplets against the air.

87. (canceled)

88. The method of claim 75, further comprising combusting the process stream leaving the one or more alpha 2^{nd} ICHEs or the one or more beta 2^{nd} ICHEs in a combustor of an oxy-fuel combustion plant.

89. The method of claim 75, further comprising cooling unit operations in an oxy-fuel combustion plant with liquid from the first or second pools of liquid.

90. The method of claim 75, further comprising creating a liquified gas product stream in an air-separation unit, wherein the liquified gas product stream is the process stream entering the alpha or beta 1^{st} ICHE.

91. The method of claim 75, wherein the process stream entering the alpha 1^{st} ICHE or the beta 1^{st} ICHE comprises a gas, a liquid, or a supercritical fluid.

92. (canceled)

93. (canceled)
